(19) United States
(12) Patent Application Publication
(10) Pub. No.: US 2024/0340921 A1
(43) Pub. Date: Oct. 10, 2024

(54) CG TRANSMISSION METHOD AND APPARATUS, USER EQUIPMENT, AND STORAGE MEDIUM

(71) Applicant: VIVO MOBILE COMMUNICATION CO., LTD., Dongguan (CN)

(72) Inventors: Yang SONG, Dongguan (CN); Rongrong SUN, Dongguan (CN)

(73) Assignee: VIVO MOBILE COMMUNICATION CO., LTD., Dongguan (CN)

(21) Appl. No.: 18/748,073

(22) Filed: Jun. 19, 2024

Related U.S. Application Data
(63) Continuation of application No. PCT/CN2022/140377, filed on Dec. 20, 2022.

(30) Foreign Application Priority Data
Dec. 21, 2021 (CN) 202111574841.X
Feb. 14, 2022 (CN) 202210135641.2

(51) Int. Cl. H04W 72/232

(52) U.S. Cl. CPC H04W 72/232

(57) ABSTRACT

This application discloses a CG transmission method and apparatus, user equipment, and a storage medium. The CG transmission method includes: determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format; and transmitting a PUSCH of the CG according to the transmission configuration of the CG and the target SRS resource set.

### CROSS-REFERENCE TO RELATED APPLICATIONS

This application is a continuation of International Application No. PCT/CN2022/140377, filed Dec. 20, 2022, which claims priority to Chinese Patent Application No. 202111574841.X, filed Dec. 21, 2021, and Chinese Patent Application No. 202210135641.2, filed Feb. 14, 2022. The entire contents of each of the above-referenced applications are expressly incorporated herein by reference.

### TECHNICAL FIELD

This application relates to the field of communication technologies, and specifically relates to a CG transmission method and apparatus, user equipment, and a storage medium.

### BACKGROUND

Currently, in a multi-transmission and reception point (Transmission and Reception Point, TRP) scenario, a Physical Uplink Shared Channel (PUSCH) repetition transmission scheme in a Time Division Multiplexing (TDM) manner for dynamic scheduling of Downlink Control Information (DCI) is supported. For Configured Grant (CG) scheduling, multi-TRP repetition transmission is also supported by using one CG configuration. However, when quantities of Sounding Reference Signal (SRS) resource sets configured for different DCI formats are different, how to determine a transmission manner of a type 1 CG is an urgent problem to be resolved.

### SUMMARY

Embodiments of this application provide a CG transmission method and apparatus, user equipment, and a storage medium.

According to a first aspect, a CG transmission method is provided. The method includes: determining, in a case that quantities of SRS resource sets configured for at least two DCI formats are different or only one DCI format is configured, target SRS resource set(s) associated with a transmission configuration of a CG according to the SRS resource sets configured for the at least two DCI formats or an SRS resource set configured for the one DCI format; and transmitting a PUSCH of the CG according to the transmission configuration of the CG and the target SRS resource set.

According to a second aspect, a CG transmission apparatus is provided. The apparatus includes a determining module and a transmission module, where the determining module is configured to determine, in a case that quantities of SRS resource sets configured for at least two DCI formats are different or only one DCI format is configured, target SRS resource set(s) associated with a transmission configuration of a CG according to the SRS resource sets configured for the at least two DCI formats or an SRS resource set configured for the one DCI format; and the transmission module is configured to transmit a PUSCH of the CG according to the transmission configuration of the CG and the target SRS resource set determined by the determining module.

According to a third aspect, User Equipment (UE) is provided. The UE includes a processor and a memory, where the memory stores a program or an instruction that can be run on the processor, and the program or the instruction is executed by the processor to implement the steps of the method according to the first aspect.

According to a fourth aspect, UE is provided, including a processor and a communication interface. The processor is configured to: determine, in a case that quantities of SRS resource sets configured for at least two DCI formats are different or only one DCI format is configured, target SRS resource set(s) associated with a transmission configuration of a CG according to the SRS resource sets configured for the at least two DCI formats or an SRS resource set configured for the one DCI format; and the communication interface is configured to transmit a PUSCH of the CG according to the transmission configuration of the CG and the target SRS resource set.

According to a fifth aspect, a readable storage medium is provided. The readable storage medium stores a program or an instruction, and the program or the instruction is executed by a processor to implement the steps of the method according to the first aspect.

According to a sixth aspect, a chip is provided. The chip includes a processor and a communication interface, the communication interface is coupled to the processor, and the processor is configured to run a program or an instruction to implement the method according to the first aspect.

According to a seventh aspect, a computer program/program product is provided. The computer program/program product is stored in a storage medium, and the computer program/program product is executed by at least one processor to implement the steps of the CG transmission method according to the first aspect.

In the embodiments of this application, in a case that quantities of SRS resource sets configured for at least two DCI formats are different or only one DCI format is configured, UE may determine target SRS resource set(s) associated with a transmission configuration of a CG according to the SRS resource sets configured for the at least two DCI formats or an SRS resource set configured for the one DCI format, to determine a transmission manner of the CG. That is, the UE uses one or more SRS resources of all SRS resource sets configured for the at least two DCI formats as an SRS resource set for transmitting a PUSCH of the CG or uses one or more SRS resources of all SRS resource sets configured for the only one configured DCI format as an SRS resource set for transmitting a PUSCH of the CG. Therefore, when the quantities of SRS resource sets configured for the at least two DCI formats are different or only the one DCI format is configured, the UE can accurately determine the transmission manner of the CG, so that the UE transmits the PUSCH of the CG.

### BRIEF DESCRIPTION OF DRAWINGS

FIG. 1 is a schematic architecture diagram of a wireless communication system according to an embodiment of this application;

FIG. 2 is a schematic diagram of a CG transmission method according to an embodiment of this application;

FIG. 3 is a schematic structural diagram of a CG transmission apparatus according to an embodiment of this application;

FIG. 4 is a schematic structural diagram of hardware of a communication device according to an embodiment of this application; and

FIG. 5 is a schematic structural diagram of hardware of UE according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

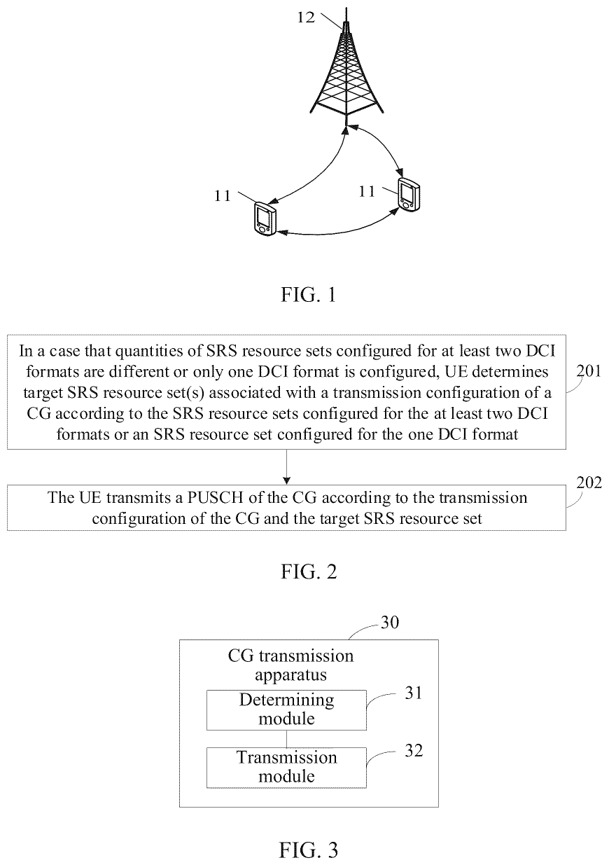

FIG. 1 is a block diagram of a wireless communication system to which the embodiments of this application can be applied. The wireless communication system includes UE 11 and a network side device 12. The UE 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the UE 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

The following describes some concepts and/or terms in a CG transmission method and apparatus, user equipment, and a storage medium provided in the embodiments of this application.

Currently, in a multi-TRP scenario, a PUSCH repetition transmission scheme in a time division multiplexing (TDM) manner for dynamic scheduling by DCI is supported. For each PUSCH repetition, a plurality of transmit beams corresponding to different TRPs are used respectively, for example, a spatial relation (spatial relation information) is indicated by an SRS resource indicator (SRI) field or a transmit beam is indicated by an uplink Transmission Configuration Indicator (TCI) field to perform sending, thereby improving reliability of PUSCH transmission.

For PUSCH repetition of Type A (slot-level), one PUSCH repetition is one PUSCH transmission occasion in each slot. For PUSCH repetition of Type B, one PUSCH repetition is nominal repetition. For example, DCI may include two SRI indicators, a transmission precoding matrix and layer indicator (Transmit precoding matrix indicator, TPMI), a power control parameter, and the like, and one 2-bit new indicator field is added to the DCI to support dynamic switching between single-TRP (STRP) and multi-TRP (MTRP), and a sequence of transmit beams for PUSCH repetitions is flexibly changed.

For configured grant (CG) scheduling, multi-TRP repetition transmission is also supported by using one CG configuration. A beam or power control mapping mechanism thereof is similar to that of dynamic scheduling, that is, two power control fields are configured in the CG configuration including: two PUSCH P0 and Alpha parameter fields (p0-PUSCH-Alpha) and two closed-loop power control fields (powerControlLoopToUse). A configuration of a type 1 CG includes two transmission configurations (for example, two path loss reference signal indexes (pathlossReferenceIndex), two SRS resource indicators (srs-ResourceIndicator), and two precoding and number of layers indicators (precodingAndNumberOfLayers)). When two SRS resource sets are configured for both DCI format 0_1 and DCI format 0_2, if two SRI indicator fields are configured in the CG, two SRS resources indicated by the two SRIs are associated with two SRS resource sets configured for the DCI format 0_1. If the CG is the Type 1 CG configured with only one power control parameter and transmission parameter, transmission of the CG is associated with the 1^{st} SRS resource set.

Retransmission of the Type 1 CG is dynamically scheduled by DCI.
(1) For a CG configured with two power control parameters, if a new indicator field included in DCI for retransmission scheduling corresponds to two SRS resource sets, a 1^{st} power control parameter configured for the CG corresponds to a 1^{st} SRS resource set, a 2n d power control parameter corresponds to a 2^{nd} SRS resource set, and a correspondence between a power control parameter and an SRS resource set is dynamically indicated according to the new indicator field.
(2) For a CG configured with two power control parameters, if DCI for retransmission scheduling is DCI format 0_0, power control parameters of all repetitions for retransmission of the CG correspond to the 1^{st} SRS resource set.
(3) For a CG configured with one power control parameter, if a new indicator field included in DCI for retransmission scheduling corresponds to two SRS resource sets, the new indicator field can only indicate “00”, that is, power control parameters of all repetitions for retransmission of the CG correspond to a 1^{st} SRS resource set.

With reference to the accompanying drawings, the following describes in detail the CG transmission method provided in the embodiments of this application by using some embodiments and application scenarios thereof.

Because SRS resource set(s) are separately configured for DCI formats 0_1 and 0_2, it implies that there can be the case that one SRS resource set is configured for one DCI format and two SRS resource sets are configured for the other DCI format. If two SRS resource sets are configured for the DCI format 0_1 and one SRS resource set is configured for the DCI format 0_2, SRS resource(s) included in the one SRS resource set for the DCI format 0_2 is/are the first N_{SRS, 0_2} SRS resource(s) in a 1^{st} SRS resource set for the DCI format 0_1. If one SRS resource set is configured for the DCI format 0_1 and two SRS resource sets are configured for the DCI format 0_2, SRS resource(s) included in a 1^{st} SRS resource set for the DCI format 0_2 is/are the first N_{SRS, 0_2} SRS resource(s) in the SRS resource set for the DCI format 0_1, and SRS resources included in a 2^{nd} SRS resource set for the DCI format 0_2 are without restriction. In some embodiments, only one of the DCI format 0_1 or the DCI format 0_2 may be configured, and one or two SRS resource sets are configured for this configured DCI format; or one or two SRS resource sets are configured for one of the DCI format 0_1 or the DCI format 0_2, and no SRS resource set is configured for the other DCI format. In this case, one or two power control parameters and transmission parameters may be configured for the Type 1 CG, and how to determine an SRS resource set corresponding to a power control parameter and transmission parameter needs to be resolved.

In the embodiments of this application, in a case that quantities of SRS resource sets configured for at least two DCI formats are different or only one DCI format is configured, UE may determine target SRS resource set(s) associated with a transmission configuration of a CG according to the SRS resource sets configured for the at least two DCI formats or an SRS resource set configured for the one DCI format, to determine a transmission manner of the CG. That is, the UE uses one or more SRS resources in all SRS resource sets configured for the at least two DCI formats as an SRS resource set for transmitting a PUSCH of the CG or uses one or more SRS resources in all SRS resource sets configured for the only one configured DCI format as an SRS resource set for transmitting a PUSCH of the CG. Therefore, when the quantities of SRS resource sets configured for the at least two DCI formats are different or only the one DCI format is configured, the UE can accurately determine the transmission manner of the CG, so that the UE transmits the PUSCH of the CG.

An embodiment of this application provides a CG transmission method. FIG. 2 is a flowchart of a CG transmission method according to an embodiment of this application. As shown in FIG. 2, the CG transmission method provided in this embodiment of this application may include the following step 201 and step 202.

Step 201: In a case that quantities of SRS resource sets configured for at least two DCI formats are different or only one DCI format is configured, UE determines target SRS resource set(s) associated with a transmission configuration of a CG according to the SRS resource sets configured for the at least two DCI formats or an SRS resource set configured for the one DCI format.

In this embodiment of this application, that quantities of SRS resource sets configured for at least two DCI formats are different or only one DCI format is configured may be understood as follows: In one case, the SRS resource sets are configured for the at least two DCI formats, and the quantities of SRS resource sets configured for the at least two DCI formats are different (for example, one SRS resource set is configured for a first DCI format, and two SRS resource sets are configured for a second DCI format, or two SRS resource sets are configured for a first DCI format, and one SRS resource set is configured for a second DCI format). In another case, no SRS resource set is configured for one DCI format of the at least two DCI formats, and at least one SRS resource set is configured for another DCI format (for example, no SRS resource set is configured for a first DCI format, and one SRS resource set or two SRS resource sets are configured for a second DCI format, or one SRS resource set or two SRS resource sets are configured for a first DCI format, and no SRS resource set is configured for a second DCI format). In still another case, a network side device configures only one DCI format (for example, a first DCI format or a second DCI format) in the at least two DCI formats and does not configure another DCI format of the at least two DCI formats, and configures at least one SRS resource set for the one DCI format (for example, only a first DCI format is configured, and one SRS resource set or two SRS resource sets are configured for the first DCI format; or only a second DCI format is configured, and one SRS resource set or two SRS resource sets are configured for the second DCI format).

It should be noted that quantities of SRS resource sets configured for at least two DCI formats are different may be understood as follows: Quantities of SRS resource sets configured for all of the at least two DCI formats are different, or quantities of SRS resource sets configured for a part of the at least two DCI formats are different.

It should be noted that the at least two DCI formats include a first DCI format and a second DCI format. The at least two DCI formats may further include DCI in other different formats, and this is not limited in this embodiment of this application. The only one configured DCI format in this embodiment of this application is one DCI format of the at least two DCI formats.

In this embodiment of this application, the first DCI format may be a DCI format 0_1, and the second DCI format may be a DCI format 0_2. The first DCI format and the second DCI format may be DCI in other different formats, and this is not limited in this embodiment of this application.

In this embodiment of this application, an SRS resource set configured for the first DCI format is configured by using a higher-layer parameter srs-ResourceSetToAddModList, and an SRS resource set configured for the second DCI format is configured by using a higher-layer parameter srs-ResourceSetToAddModListDCI-0-2.

In this embodiment of this application, an SRS resource set may include at least one SRS resource. For example, the SRS resource sets configured for the at least two DCI formats include an SRS resource set 1, an SRS resource set 2, an SRS resource set 3, and an SRS resource set 4, where the SRS resource set 1 includes N1 SRS resources, the SRS resource set 2 includes N2 SRS resources, the SRS resource set 3 includes N3 SRS resources that are the first N3 SRS resources in the SRS resource set 1, and the SRS resource set 4 includes N4 SRS resources that are the first N4 SRS resources in the SRS resource set 2.

In this embodiment of this application, the CG may be a CG of a target type, for example, a CG of a type 1 or a CG of another type.

In this embodiment of this application, the transmission configuration of the CG includes at least one of the following: precoding and number of layers information (for example, a precoding and number of layers indicator field (precodingAndNumberOfLayers)), SRS resource indication information (for example, an SRS resource indicator field (srs-ResourceIndicator)), power control information (for example, a P0 and Alpha parameter field (p0-PUSCH-Alpha)), a closed-loop power control field (powerControlLoopToUse), a path loss reference signal index (pathlossReferenceIndex), or the like.

In this embodiment of this application, the transmission configuration of the CG may be at least one transmission configuration, and each transmission configuration is associated with one SRS resource set, that is, an SRS resource indicated by SRS resource indication information (SRI) is one SRS resource in the corresponding SRS resource set. If the transmission configuration of the CG is one transmission configuration, an SRS resource set associated with the determined transmission configuration of the CG is one SRS resource set. If the transmission configuration of the CG is a plurality of transmission configurations, SRS resource sets associated with the determined transmission configuration of the CG are a plurality of SRS resource sets (the plurality of transmission configurations are associated with the plurality of SRS resource sets in a one-to-one manner).

It should be noted that SRS resource sets associated with the plurality of transmission configurations are different; or SRS resource sets associated with a part of the plurality of transmission configurations are different; or SRS resource sets associated with the plurality of transmission configurations are the same (that is, the plurality of transmission configurations are associated with a same SRS resource set).

It can be understood that the UE may determine an association between the transmission configuration of the CG and an SRS resource set according to status of SRS configurations for different DCI formats, that is, determine the SRS resource set associated with the transmission configuration of the CG.

For example, as shown in Table 1, Table 1 shows an association between SRS resource sets configured for two DCI formats and the transmission configuration of the CG provided in this embodiment of this application.

TABLE 1

| | | SRS resource set | SRS resource sets |
|---|---|---|---|
| SRS resource set | SRS resource set | associated with one | associated with two |
| configured for the | configured for the | transmission configuration | transmission configurations |
| DCI format 0_1 | DCI format 0_2 | configured by the CG | configured by the CG |
| SRS resource set 1 | No SRS resource set | (1a): SRS resource set 1 | (2a): |
| SRS resource set 2 | is configured or the | | SRS resource set 1 |
| | DCI format 0_2 is not | | SRS resource set 2 |
| | configured | | |
| SRS resource set 1 | SRS resource set 3 | (1b): SRS resource set 1 | (2b): |
| SRS resource set 2 | | or | SRS resource set 1 |
| | | (1c): SRS resource set 3 | SRS resource set 2 |
| No SRS resource set | SRS resource set 3 | (1d): SRS resource set 3 | (2c): |
| is configured or the | SRS resource set 4 | | SRS resource set 3 |
| DCI format 0_1 is not | | | SRS resource set 4 |
| configured | | | |
| SRS resource set 1 | SRS resource set 3 | (1e): SRS resource set 1 | (2d): |
| | SRS resource set 4 | or | SRS resource set 3 |
| | | (1f): SRS resource set 3 | SRS resource set 4 |
| | | | or |
| | | | (2e): |
| | | | SRS resource set 1 |
| | | | SRS resource set 4 |
| No SRS resource set | SRS resource set 3 | (1g): SRS resource set 3 | |
| is configured or the | | | |
| DCI format 0_1 is not | | | |
| configured | | | |

For example, in the foregoing Table 1, if two SRS resource sets (the SRS resource set 1 and the SRS resource set 2) are configured for the DCI format 0_1, and no SRS resource set is configured for the DCI format 0_2 or the DCI format 0_2 is not configured, in one case, the CG is configured with one transmission configuration, and an SRS resource set associated with the one transmission configuration is the SRS resource set 1 (that is, a 1^{st} SRS resource set) of the SRS resource sets configured for the DCI format 0_1; and in another case, the CG is configured with two transmission configurations, and SRS resource sets associated with the two transmission configurations are the SRS resource set 1 and the SRS resource set 2 (that is, a 1^{st} SRS resource set associated with a 1^{st} transmission configuration and a 2^{nd} SRS resource set associated with a 2^{nd} transmission configuration) of the SRS resource sets configured for the DCI format 0_1. It should be noted that, for other cases in the table (that is, an association between an SRS resource set configured for a DCI format and the transmission configuration of the CG), details are not listed one by one herein.

In this embodiment of this application, if the SRS resource sets configured for all the at least two DCI formats (for example, the DCI format 0_1 and the DCI format 0_2) are two SRS resource sets (for example, the SRS resource set 1 and the SRS resource set 2 are configured for the DCI format 0_1, and the SRS resource set 3 and the SRS resource set 4 are configured for the DCI format 0_2), in one case, the CG is configured with one transmission configuration, and an SRS resource set associated with the one transmission configuration is the SRS resource set 1 (that is, a 1^{st} SRS resource set) of the SRS resource sets configured for the DCI format 0_1; and in another case, the CG is configured with two transmission configurations, and SRS resource sets associated with the two transmission configurations are the SRS resource set 1 and the SRS resource set 2 in the SRS resource sets configured for the DCI format 0_1.

In a first implementation of this embodiment of this application, the transmission configuration of the CG is one transmission configuration. The foregoing step 201 may be implemented by using the following step 201a.

Step 201a: In a case that the transmission configuration of the CG is one transmission configuration, if quantities of SRS resource sets configured for at least two DCI formats are different or only one DCI format is configured, the UE determines a 1^{st} SRS resource set of SRS resource set(s) configured for a target DCI format as the target SRS resource set.

In this embodiment of this application, the target DCI format is the only one configured DCI format or any DCI format of the at least two DCI formats.

It can be understood that in a case that the transmission configuration of the CG is one transmission configuration, if the quantities of SRS resource sets configured for the at least two DCI formats are different, the UE may determine a 1^{st} SRS resource set of SRS resource set(s) configured for any DCI format of the at least two DCI formats as an SRS resource set (that is, the target SRS resource set) associated with the one transmission configuration; or if the only one DCI format (for example, the first DCI format or the second DCI format) is configured, the UE may determine a 1^{st} SRS resource set of SRS resource set(s) configured for the only configured first DCI format as an SRS resource set associated with the one transmission configuration, or determine a 1^{st} SRS resource set of SRS resource set(s) configured for the only configured second DCI format as an SRS resource set associated with the one transmission configuration.

The following describes a specific solution in which the UE determines the target SRS resource set associated with the transmission configuration of the CG in a case that the transmission configuration of the CG is one transmission configuration by using specific implementations (that is, the following manner 1 to manner 4).

In the manner 1 of this embodiment of this application, the foregoing step 201 may be implemented by using the following step 201a1.

Step 201a1: In a case that the transmission configuration of the CG is one transmission configuration, if at least one SRS resource set is configured for a first DCI format of the at least two DCI formats, the UE determines a 1^{st} SRS resource set of the at least one SRS resource set as the target SRS resource set.

It should be noted that, in the foregoing step 201a1, if one SRS resource set is configured for the first DCI format, the 1^{st} SRS resource set is the one SRS resource set.

It can be understood that, in the manner 1, in a case that the quantities of SRS resource sets configured for the at least two DCI formats are different, the 1^{st} SRS resource set of the SRS resource set(s) configured for the first DCI format is the target SRS resource set.

If one SRS resource set is configured for the first DCI format and at least two SRS resource sets are configured or zero SRS resource sets (that is, no SRS resource set is configured for the second DCI format) are configured for the second DCI format, the UE may determine the one SRS resource set (that is, one SRS resource set configured for the first DCI format) as the target SRS resource set (for example, (1e) in the foregoing Table 1).

In some embodiments, if at least two SRS resource sets are configured for the first DCI format and zero SRS resource sets or one SRS resource set is configured for the second DCI format, the UE may determine a 1^{st} SRS resource set of the at least two SRS resource sets (that is, a 1^{st} SRS resource set of the at least two SRS resource sets configured for the first DCI format) as the target SRS resource set (for example, (1a) and (1b) in the foregoing Table 1).

In the manner 2 of this embodiment of this application, the foregoing step 201 may be implemented by using the following step 201a2.

Step 201a2: In a case that the transmission configuration of the CG is one transmission configuration, if no SRS resource set is configured for a first DCI format of the at least two DCI formats or only a second DCI format is configured, the UE determines a 1^{st} SRS resource set of SRS resource set(s) configured for the second DCI format as the target SRS resource set.

It can be understood that in the manner 2, (1) in a case that the quantities of SRS resource sets configured for the at least two DCI formats are different, the 1^{st} SRS resource set of the SRS resource set(s) configured for the second DCI format is the target SRS resource set.

If no SRS resource set is configured for the first DCI format and one SRS resource set is configured for the second DCI format, the UE may determine the one SRS resource set (that is, one SRS resource set configured for the second DCI format) as the target SRS resource set (for example, (1g) in the foregoing Table 1).

In some embodiments, if no SRS resource set is configured for the first DCI format and at least two SRS resource sets are configured for the second DCI format, the UE may determine a 1^{st} SRS resource set of the at least two SRS resource sets as the target SRS resource set (for example, (1d) in the foregoing Table 1).
(2) In a case that only the second DCI format is configured and the first DCI format is not configured, the 1^{st} SRS resource set of the SRS resource set(s) configured for the second DCI format is the target SRS resource set.

If one SRS resource set is configured for the second DCI format, the UE may determine the one SRS resource set (that is, one SRS resource set configured for the second DCI format) as the target SRS resource set.

In some embodiments, if at least two SRS resource sets are configured for the second DCI format, the UE may determine a 1^{st} SRS resource set of the at least two SRS resource sets as the target SRS resource set.

In the manner 3 of this embodiment of this application, the foregoing step 201 may be implemented by using the following step 201a3 or step 201a4.

Step 201a3: In a case that the transmission configuration of the CG is one transmission configuration, if at least two SRS resource sets are configured for one DCI format of the at least two DCI formats and no SRS resource set is configured for another DCI format of the at least two DCI formats, the UE determines a 1^{st} SRS resource set of the at least two SRS resource sets as the target SRS resource set.

It can be understood that in the manner 3, in a case that the quantities of SRS resource sets configured for either of the at least two DCI formats are different, if one SRS resource set is not configured for the at least two DCI formats (that is, a quantity of SRS resource sets configured for each of the at least two DCI formats is not one), a 1^{st} SRS resource set in a DCI format for which at least two SRS resource sets are configured is the target SRS resource set.

If at least two SRS resource sets are configured for the first DCI format and no SRS resource set is configured for the second DCI format, the UE may determine a 1^{st} SRS resource set of the at least two SRS resource sets (that is, a 1^{st} SRS resource set of the at least two SRS resource sets configured for the first DCI format) as the target SRS resource set (for example, (1a) in the foregoing Table 1).

In some embodiments, if at least two SRS resource sets are configured for the second DCI format and no SRS resource set is configured for the first DCI format, the UE may determine a 1^{st} SRS resource set of the at least two SRS resource sets (that is, a 1^{st} SRS resource set of the at least two SRS resource sets configured for the second DCI format) as the target SRS resource set (for example, (1d) in the foregoing Table 1).

Step 201a4: In a case that the transmission configuration of the CG is one transmission configuration, if only the one DCI format is configured and at least two SRS resource sets are configured for the one DCI format, the UE determines a 1^{st} SRS resource set of the at least two SRS resource sets as the target SRS resource set.

It can be understood that if only a first DCI format is configured and at least two SRS resource sets are configured for the first DCI format, the UE determines a 1^{st} SRS resource set of the at least two SRS resource sets (that is, a 1^{st} SRS resource set of the at least two SRS resource sets configured for the first DCI format) as the target SRS resource set; or if only a second DCI format is configured and at least two SRS resource sets are configured for the second DCI format, the UE determines a 1^{st} SRS resource set of the at least two SRS resource sets (that is, a 1^{st} SRS resource set of the at least two SRS resource sets configured for the second DCI format) as the target SRS resource set.

In the manner 4 of this embodiment of this application, the foregoing step 201 may be implemented by using the following step 201a5.

Step 201a5: In a case that the transmission configuration of the CG is one transmission configuration, if one SRS resource set is configured for one DCI format of the at least two DCI formats, the UE determines the one SRS resource set as the target SRS resource set.

It can be understood that, in the manner 4, in a case that the quantities of SRS resource sets configured for the at least two DCI formats are different, an SRS resource set for a DCI format for which only one SRS resource set is configured is the target SRS resource set.

If one SRS resource set is configured for the first DCI format and no SRS resource set or at least two SRS resource sets are configured for the second DCI format, the UE may determine the one SRS resource set (that is, one SRS resource set configured for the first DCI format) as the target SRS resource set (for example, (1e) in the foregoing Table 1).

In some embodiments, if one SRS resource set is configured for the second DCI format and no SRS resource set or at least two SRS resource sets are configured for the first DCI format, the UE may determine the one SRS resource set (that is, one SRS resource set configured for the second DCI format) as the target SRS resource set (for example, (1c) and (1g) in the foregoing Table 1). In a second implementation of this embodiment of this application, the transmission configuration of the CG is at least two transmission configurations. The foregoing step 201 may be implemented by using the following step 201b or step 201c.

Step 201b: In a case that the transmission configuration of the CG is at least two transmission configurations, if no SRS resource set is configured for one DCI format of the at least two DCI formats and one SRS resource set is configured for another DCI format of the at least two DCI formats, the UE determines the one SRS resource set as an SRS resource set associated with a 1^{st} transmission configuration and a 2^{nd} transmission configuration of the at least two transmission configurations.

It can be understood that in a case that the transmission configuration of the CG is at least two transmission configurations, if there is no SRS resource set for the first DCI format (that is, no SRS resource set is configured for the first DCI format or the first DCI format is not configured) and only one SRS resource set is configured for the second DCI format, the UE may determine the one SRS resource set (that is, one SRS resource set configured for the second DCI format) as an SRS resource set associated with the at least two transmission configurations, that is, an SRS resource set associated with each transmission configuration of the at least two transmission configurations is one SRS resource set configured for the second DCI format; or if there is no SRS resource set for the second DCI format (that is, no SRS resource set is configured for the second DCI format or the second DCI format is not configured) and only one SRS resource set is configured for the first DCI format, the UE may determine the one SRS resource set (that is, one SRS resource set configured for the first DCI format) as an SRS resource set associated with the at least two transmission configurations, that is, an SRS resource set associated with each transmission configuration of the at least two transmission configurations is one SRS resource set configured for the first DCI format.

Step 201c: In a case that the transmission configuration of the CG is at least two transmission configurations, if only the one DCI format is configured and one SRS resource set is configured for the one DCI format, the UE determines the one SRS resource set as an SRS resource set associated with a 1^{st} transmission configuration and a 2^{nd} transmission configuration of the at least two transmission configurations.

It can be understood that in a case that the transmission configuration for the CG is at least two transmission configurations, if only the first DCI format is configured and only one SRS resource set is configured for the first DCI format, the UE may determine the one SRS resource set (that is, one SRS resource set configured for the first DCI format) as an SRS resource set associated with the at least two transmission configurations, that is, an SRS resource set associated with each transmission configuration of the at least two transmission configurations is one SRS resource set configured for the first DCI format; or if only the second DCI format is configured and only one SRS resource set is configured for the second DCI format, the UE may determine the one SRS resource set (that is, one SRS resource set configured for the second DCI format) as an SRS resource set associated with the at least two transmission configurations, that is, an SRS resource set associated with each transmission configuration of the at least two transmission configurations is one SRS resource set configured for the second DCI format.

In a third implementation of this embodiment of this application, the transmission configuration of the CG is at least two transmission configurations. The foregoing step 201 may be implemented by using the following step 201d.

Step 201d: In a case that the transmission configuration of the CG is at least two transmission configurations, if only the one DCI format is configured and at least two SRS resource sets are configured for the one DCI format, the UE determines a 1^{st} SRS resource set of the at least two SRS resource sets configured for the one DCI format as an SRS resource set associated with a 1^{st} transmission configuration of the at least two transmission configurations, and determines a 2^{nd} SRS resource set of the at least two SRS resource sets configured for the one DCI format as an SRS resource set associated with a 2^{nd} transmission configuration of the at least two transmission configurations.

It can be understood that in a case that the transmission configuration of the CG is at least two transmission configurations, if only a first DCI format is configured and at least two SRS resource sets are configured for the first DCI format, the UE may determine a 1^{st} SRS resource set of the at least two SRS resource sets (that is, the at least two SRS resource sets configured for the first DCI format) as an SRS resource set associated with the 1^{st} transmission configuration, and determine a 2^{nd} SRS resource set of the at least two SRS resource sets as an SRS resource set associated with the 2^{nd} transmission configuration; or if only a second DCI format is configured and at least two SRS resource sets are configured for the second DCI format, the UE may determine a 1^{st} SRS resource set of the at least two SRS resource sets (that is, the at least two SRS resource sets configured for the second DCI format) as an SRS resource set associated with the 1^{st} transmission configuration, and determine a 2^{nd} SRS resource set of the at least two SRS resource sets as an SRS resource set associated with the 2^{nd} transmission configuration.

In this embodiment of this application, if at least two SRS resource sets are not configured for either of the at least two DCI formats (that is, a quantity of SRS resource sets configured for each of the at least two DCI formats is not at least two), the UE does not expect the transmission configuration of the CG to be at least two transmission configurations, or the transmission configuration of the CG cannot be at least two transmission configurations. In other words, in a case that there are at least two transmission configurations configured for the transmission configuration of the CG, there is at least one DCI format of at least two DCI formats, where at least two SRS resource sets must be configured for each of the at least one DCI format.

In a fourth implementation of this embodiment of this application, the transmission configuration of the CG is at least two transmission configurations. The foregoing step 201 may be implemented by using the following step 201e.

Step 201e: In a case that the transmission configuration of the CG is at least two transmission configurations, if at least two SRS resource sets are configured for only one DCI format of the at least two DCI formats, the UE determines at least two SRS resource sets of the SRS resource sets configured for the at least two DCI formats as SRS resource sets associated with the at least two transmission configurations.

The at least two transmission configurations are associated, in a one-to-one manner, with the at least two SRS resource sets of the SRS resource sets configured for the at least two DCI formats, that is, a 1^{st} transmission configuration is associated with a 1^{st} SRS resource set, and a 2^{nd} transmission configuration is associated with a 2^{nd} SRS resource set.

It can be understood that, in a case that the transmission configuration of the CG is at least two transmission configurations, if at least two SRS resource sets are configured for one DCI format of the at least two DCI formats, the UE may determine at least two SRS resource sets of the SRS resource sets configured for the one DCI format (that is, a DCI format for which at least two SRS resource sets are configured) of the at least two DCI formats as SRS resource sets associated with the at least two transmission configurations. In this manner, SRS resource sets associated with each transmission configuration of the at least two transmission configurations are different.
(1) In a case that the transmission configuration of the CG is at least two transmission configurations, if no SRS resource set is configured for the first DCI format or the first DCI format is not configured, at least two SRS resource sets must be configured for the second DCI format; or if no SRS resource set is configured for the second DCI format or the second DCI format is not configured, at least two SRS resource sets must be configured for the first DCI format.
(2) In a case that the transmission configuration of the CG is at least two transmission configurations, if one SRS resource set is configured for the first DCI format, at least two SRS resource sets must be configured for the second DCI format; or if one SRS resource set is configured for the second DCI format, at least two SRS resource sets must be configured for the first DCI format.
(3) In a case that the transmission configuration of the CG is at least two transmission configurations, if at least two SRS resource sets are configured for the first DCI format, at least one SRS resource set or zero SRS resource sets are configured for the second DCI format; or if at least two SRS resource sets are configured for the second DCI format, at least one SRS resource set or zero SRS resource sets are configured for the first DCI format.

The following describes a specific solution in which the UE determines the target SRS resource set associated with the transmission configuration of the CG in a case that the transmission configuration of the CG is at least two transmission configurations by using specific implementations (that is, the following manner 5 to manner 8).

In the manner 5 of this embodiment of this application, the foregoing step 201 may be implemented by using the following step 201e1.

Step 201e1: In a case that the transmission configuration of the CG is at least two transmission configurations, if no SRS resource set is configured for one DCI format of the at least two DCI formats and at least two SRS resource sets are configured for another DCI format of the at least two DCI formats, the UE determines a 1^{st} SRS resource set of the at least two SRS resource sets configured for the another DCI format as an SRS resource set associated with a 1^{st} transmission configuration of the at least two transmission configurations, and determines a 2^{nd} SRS resource set of the at least two SRS resource sets configured for the another DCI format as an SRS resource set associated with a 2^{nd} transmission configuration of the at least two transmission configurations.

It can be understood that, in the manner 5, if no SRS resource set is configured for the first DCI format and at least two SRS resource sets are configured for the second DCI format, the UE determines a 1^{st} SRS resource set of the at least two SRS resource sets configured for the second DCI format as the SRS resource set associated with the 1^{st} transmission configuration, and determines a 2^{nd} SRS resource set of the at least two SRS resource sets configured for the second DCI format as the SRS resource set associated with the 2^{nd} transmission configuration; or if no SRS resource set is configured for the second DCI format and at least two SRS resource sets are configured for the first DCI format, the UE determines a 1^{st} SRS resource set of the at least two SRS resource sets configured for the first DCI format as the SRS resource set associated with the 1^{st} transmission configuration, and determines a 2^{nd} SRS resource set of the at least two SRS resource sets configured for the first DCI format as the SRS resource set associated with the 2^{nd} transmission configuration.

In the manner 6 of this embodiment of this application, the foregoing step 201 may be implemented by using the following step 201e2 or step 201e3.

Step 201e2: In a case that the transmission configuration of the CG is at least two transmission configurations, if one SRS resource set is configured for a first DCI format of the at least two DCI formats and at least two SRS resource sets are configured for a second DCI format of the at least two DCI formats, the UE determines the one SRS resource set as an SRS resource set associated with a 1^{st} transmission configuration of the at least two transmission configurations, and determines a 2^{nd} SRS resource set of the SRS resource sets configured for the second DCI format as an SRS resource set associated with a 2^{nd} transmission configuration of the at least two transmission configurations.

For example, with reference to the foregoing Table 1, for example, (2e) in Table 1, if one SRS resource set (that is, the SRS resource set 1) is configured for the DCI format 0_1, and two SRS resource sets (that is, the SRS resource set 3 and the SRS resource set 4) are configured for the DCI format 0_2, the SRS resource set associated with the 1^{st} transmission configuration is the SRS resource set (that is, the SRS resource set 1) for the DCI format 0_1, and the SRS resource set associated with the 2^{nd} transmission configuration is a 2^{nd} SRS resource set (that is, the SRS resource set 4) for the DCI format 0_2.

Step 201e3: In a case that the transmission configuration of the CG is at least two transmission configurations, if one SRS resource set is configured for a first DCI format of the at least two DCI formats and at least two SRS resource sets are configured for a second DCI format of the at least two DCI formats, the UE determines a 1^{st} SRS resource set of the SRS resource sets configured for the second DCI format as an SRS resource set associated with a 1^{st} transmission configuration of the at least two transmission configurations, and determines a 2^{nd} SRS resource set of the SRS resource sets configured for the second DCI format as an SRS resource set associated with a 2^{nd} transmission configuration of the at least two transmission configurations.

In the manner 7 of this embodiment of this application, the foregoing step 201 may be implemented by using the following step 201e4.

Step 201e4: In a case that the transmission configuration of the CG is at least two transmission configurations, if at least two SRS resource sets are configured for a first DCI format of the at least two DCI formats, the UE determines a 1^{st} SRS resource set of the at least two SRS resource sets configured for the first DCI format as an SRS resource set associated with a 1^{st} transmission configuration of the at least two transmission configurations, and determines a 2^{nd} SRS resource set of the at least two SRS resource sets configured for the first DCI format as an SRS resource set associated with a 2^{nd} transmission configuration of the at least two transmission configurations.

It can be understood that, in the manner 7, if at least two SRS resource sets are configured for the first DCI format and one SRS resource set or zero SRS resource sets are configured for the second DCI format, the UE may separately determine a 1^{st} SRS resource set and a 2^{nd} SRS resource set of the at least two SRS resource sets configured for the first DCI format as the SRS resource set associated with the 1^{st} transmission configuration and the SRS resource set associated with the 2^{nd} transmission configuration (for example, (2a) and (2b) in the foregoing Table 1).

In the manner 8 of this embodiment of this application, the foregoing step 201 may be implemented by using the following step 201e5.

Step 201e5: In a case that the transmission configuration of the CG is at least two transmission configurations, if at least two SRS resource sets are configured for any one DCI format of the at least two DCI formats, the UE determines a 1^{st} SRS resource set of the at least two SRS resource sets configured for the any one DCI format as an SRS resource set associated with a 1^{st} transmission configuration of the at least two transmission configurations, and determines a 2^{nd} SRS resource set of the at least two SRS resource sets configured for the any one DCI format as an SRS resource set associated with a 2^{nd} transmission configuration of the at least two transmission configurations.

It can be understood that, in the manner 8, if at least two SRS resource sets are configured for one DCI format and one SRS resource set or zero SRS resource sets are configured for another DCI format (for example, at least two SRS resource sets are configured for the second DCI format and the first DCI format is not configured, or at least two SRS resource sets are configured for the second DCI format and one SRS resource set or zero SRS resource sets are configured for the first DCI format), the UE may separately determine a 1^{st} SRS resource set and a 2^{nd} SRS resource set of the at least two SRS resource sets configured for the one DCI format as the SRS resource set associated with the 1^{st} transmission configuration and the SRS resource set associated with the 2^{nd} transmission configuration. In other words, if two SRS resource sets are configured for only one DCI format, the 1^{st} transmission configuration is associated with a 1^{st} SRS resource set for the DCI format, and the 2^{nd} transmission configuration is associated with a 2^{nd} SRS resource set for the DCI format (for example, (2a), (2b), (2c), and (2d) in the foregoing Table 1).

For example, with reference to the foregoing Table 1, for example, (2c) in Table 1, if no SRS resource set is configured for the DCI format 0_1 and two SRS resource sets are configured for the DCI format 0_2 (that is, the SRS resource set 3 and the SRS resource set 4), the SRS resource set associated with the 1^{st} transmission configuration is a 1^{st} SRS resource set (that is, the SRS resource set 3) for the DCI format 0_2, and the SRS resource set associated with the 2^{nd} transmission configuration is a 2^{nd} SRS resource set (that is, the SRS resource set 4) for the DCI format 0_2.

In another implementation of this embodiment of this application, the transmission configuration of the CG is one transmission configuration. The foregoing step 201 may be implemented by using the following step 201f or step 201g.

Step 201f: In a case that the transmission configuration of the CG is one transmission configuration, configure at least one SRS resource set for the target DCI format of the two DCI formats.

In some embodiments, the target DCI is a DCI format 0_1.

It can be understood that in a case that the transmission configuration of the CG is one transmission configuration, the terminal does not expect that no SRS resource set is configured for the DCI format 0_1.

Step 201g: In a case that the transmission configuration of the CG is one transmission configuration, when no SRS resource set is configured for the target DCI format, a terminal ignores target parameter indication(s) in the transmission configuration of the CG.

In some embodiments, the target parameter indication(s) is/are at least one of the following: an SRI (srs-ResourceIndicator) or a TPMI (precodingAndNumberOfLayers).

In a fifth implementation of this embodiment of this application, the transmission configuration of the CG is two transmission configurations. The foregoing step 201 may be implemented by using the following step 201h or step 201i.

Step 201h: In a case that the transmission configuration of the CG is two transmission configurations, configure at least two SRS resource sets for the target DCI format of the two DCI formats.

In some embodiments, the target DCI is a DCI format 0_1.

It can be understood that in a case that the transmission configuration of the CG is two transmission configurations, the terminal does not expect that one SRS resource set or no SRS resource set is configured for the DCI format 0_1.

Step 201i: In a case that the transmission configuration of the CG is two transmission configurations, when only one SRS resource set is configured for the target DCI format, a terminal ignores a 2^{nd} transmission configuration of the CG.

In some embodiments, the 2^{nd} transmission configuration is at least one of the following: a second SRI (srs-ResourceIndicator2) or a second TPMI (precodingAndNumberOfLayers2).

In a sixth implementation of this embodiment of this application, the foregoing step 201 may be implemented by using the following step 201j or step 201k.

Step 201j: When no SRS resource set is configured for the target DCI format, a terminal transmits the CG by using a single-antenna port.

In some embodiments, the target DCI is a DCI format 0_1.

In some embodiments, step 201j may be used together with step 201g. When no SRS resource set is configured for the target DCI format, the terminal ignores target parameter indication(s) in the transmission configuration of the CG, and transmits the CG by using a single-antenna port.

Step 201k: When no SRS resource set is configured for a target DCI format, determine SRS resource set(s) in a target configuration as the SRS resource set.

In some embodiments, the target configuration is an RRC release configuration.

Step 202: The UE transmits a PUSCH of the CG according to the transmission configuration of the CG and the target SRS resource set.

In this embodiment of this application, the target SRS resource set is used by the UE to transmit an uplink data channel of the CG.

According to the CG transmission method provided in this embodiment of this application, in a case that quantities of SRS resource sets configured for at least two DCI formats are different or only one DCI format is configured, UE may determine target SRS resource set(s) associated with a transmission configuration of a CG according to the SRS resource sets configured for the at least two DCI formats or an SRS resource set configured for the one DCI format, to determine a transmission manner of the CG. That is, the UE uses one or more SRS resources of all SRS resource sets configured for the at least two DCI formats as an SRS resource set for transmitting a PUSCH of the CG or uses one or more SRS resources of all SRS resource sets configured for the only one configured DCI format as an SRS resource set for transmitting a PUSCH of the CG. Therefore, when the quantities of SRS resource sets configured for the at least two DCI formats are different or only the one DCI format is configured, an association between the transmission configuration of the CG and an SRS resource set makes the protocol more complete. In this way, when the quantities of SRS resource sets configured for the at least two DCI formats are different or only the one DCI format is configured, the UE can accurately determine the transmission manner of the CG, so that the UE transmits the PUSCH of the CG.

It should be noted that, the CG transmission method provided in this embodiment of this application may be performed by a CG transmission apparatus, or a control module that is in the CG transmission apparatus and that is configured to perform the CG transmission method.

FIG. 3 is a schematic structural diagram of a CG transmission apparatus according to an embodiment of this application. As shown in FIG. 3, a CG transmission apparatus 30 may include a determining module 31 and a transmission module 32.

The determining module 31 is configured to determine, in a case that quantities of SRS resource sets configured for at least two DCI formats are different or only one DCI format is configured, target SRS resource set(s) associated with a transmission configuration of a CG according to the SRS resource sets configured for the at least two DCI formats or an SRS resource set configured for the one DCI format. The transmission module 32 is configured to transmit a PUSCH of the CG according to the transmission configuration of the CG and the target SRS resource set determined by the determining module 31.

In an implementation, the determining module 31 is configured to: in a case that the transmission configuration of the CG is one transmission configuration, determine a 1^{st} SRS resource set of SRS resource set(s) configured for a target DCI format as the target SRS resource set, where the target DCI format is the one DCI format or any DCI format of the at least two DCI formats.

In an implementation, the determining module 31 is configured to: in a case that the transmission configuration of the CG is one transmission configuration, if at least one SRS resource set is configured for a first DCI format of the at least two DCI formats, determine a 1^{st} SRS resource set of the at least one SRS resource set as the target SRS resource set.

In an implementation, the determining module 31 is configured to: in a case that the transmission configuration of the CG is one transmission configuration, if no SRS resource set is configured for a first DCI format of the at least two DCI formats or only a second DCI format is configured, determine a 1^{st} SRS resource set of SRS resource set(s) configured for the second DCI format as the target SRS resource set.

In an implementation, the determining module 31 is configured to: in a case that the transmission configuration of the CG is one transmission configuration, if at least two SRS resource sets are configured for one DCI format of the at least two DCI formats and no SRS resource set is configured for another DCI format of the at least two DCI formats, determine a 1^{st} SRS resource set of the at least two SRS resource sets as the target SRS resource set; or in a case that the transmission configuration of the CG is one transmission configuration, if only the one DCI format is configured and at least two SRS resource sets are configured for the one DCI format, determine a 1^{st} SRS resource set of the at least two SRS resource sets as the target SRS resource set.

In an implementation, the determining module 31 is configured to: in a case that the transmission configuration of the CG is one transmission configuration, if one SRS resource set is configured for one DCI format of the at least two DCI formats, determine the one SRS resource set as the target SRS resource set.

In an implementation, the determining module 31 is configured to:
in a case that the transmission configuration of the CG is one transmission configuration, configure at least one SRS resource set for the target DCI format of the two DCI formats.

In an implementation, the determining module 31 is configured to:
in a case that the transmission configuration of the CG is two transmission configurations, configure at least two SRS resource sets for the target DCI format of the two DCI formats.

In an implementation, the determining module 31 is configured to:
in a case that the transmission configuration of the CG is one transmission configuration, when no SRS resource set is configured for the target DCI format, ignore target parameter indication(s) in the transmission configuration of the CG.

In an implementation, the determining module 31 is configured to:
in a case that the transmission configuration of the CG is two transmission configurations, when only one SRS resource set is configured for the target DCI format, ignore a 2^{nd} transmission configuration of the CG.

In an implementation, the determining module 31 is configured to:
when no SRS resource set is configured for the target DCI format, transmit, by a terminal, the CG by using a single-antenna port.

In an implementation, the determining module 31 is configured to:
when no SRS resource set is configured for a target DCI format, determine SRS resource set(s) in a target configuration as the SRS resource set.

In an implementation, the determining module 31 is configured to: in a case that the transmission configuration of the CG is at least two transmission configurations, if no SRS resource set is configured for one DCI format of the at least two DCI formats and one SRS resource set is configured for another DCI format of the at least two DCI formats, determine the one SRS resource set as an SRS resource set associated with a 1^{st} transmission configuration and a 2^{nd} transmission configuration of the at least two transmission configurations; or in a case that the transmission configuration of the CG is at least two transmission configurations, if only the one DCI format is configured and one SRS resource set is configured for the one DCI format, determine the one SRS resource set as an SRS resource set associated with a 1^{st} transmission configuration and a 2^{nd} transmission configuration of the at least two transmission configurations.

In an implementation, the determining module 31 is configured to: in a case that the transmission configuration of the CG is at least two transmission configurations, if only the one DCI format is configured and at least two SRS resource sets are configured for the one DCI format, determine a 1^{st} SRS resource set of the at least two SRS resource sets configured for the one DCI format as an SRS resource set associated with a 1^{st} transmission configuration of the at least two transmission configurations, and determine a 2^{nd} SRS resource set of the at least two SRS resource sets configured for the one DCI format as an SRS resource set associated with a 2^{nd} transmission configuration of the at least two transmission configurations.

In an implementation, the determining module 31 is configured to: in a case that the transmission configuration of the CG is at least two transmission configurations, if at least two SRS resource sets are configured for only one DCI format of the at least two DCI formats, determine at least two SRS resource sets of the SRS resource sets configured for the at least two DCI formats as SRS resource sets associated with the at least two transmission configurations, where the at least two transmission configurations are associated, in a one-to-one manner, with the at least two SRS resource sets of the SRS resource sets configured for the at least two DCI formats.

In an implementation, the determining module 31 is configured to: in a case that the transmission configuration of the CG is at least two transmission configurations, if no SRS resource set is configured for one DCI format of the at least two DCI formats and at least two SRS resource sets are configured for another DCI format of the at least two DCI formats, determine a 1^{st} SRS resource set of the at least two SRS resource sets configured for the another DCI format as an SRS resource set associated with a 1^{st} transmission configuration of the at least two transmission configurations, and determine a 2^{nd} SRS resource set of the at least two SRS resource sets configured for the another DCI format as an SRS resource set associated with a 2^{nd} transmission configuration of the at least two transmission configurations.

In an implementation, the determining module 31 is configured to: in a case that the transmission configuration of the CG is at least two transmission configurations, if one SRS resource set is configured for a first DCI format of the at least two DCI formats and at least two SRS resource sets are configured for a second DCI format of the at least two DCI formats, determine the one SRS resource set as an SRS resource set associated with a 1^{st} transmission configuration of the at least two transmission configurations, and determine a 2^{nd} SRS resource set of the SRS resource sets configured for the second DCI format as an SRS resource set associated with a 2^{nd} transmission configuration of the at least two transmission configurations; or determine a 1^{st} SRS resource set of the SRS resource sets configured for the second DCI format as an SRS resource set associated with a 1^{st} transmission configuration of the at least two transmission configurations, and determine a 2^{nd} SRS resource set of the SRS resource sets configured for the second DCI format as an SRS resource set associated with a 2^{nd} transmission configuration of the at least two transmission configurations.

In an implementation, the determining module 31 is configured to: in a case that the transmission configuration of the CG is at least two transmission configurations, if at least two SRS resource sets are configured for a first DCI format of the at least two DCI formats, determine a 1^{st} SRS resource set of the at least two SRS resource sets configured for the first DCI format as an SRS resource set associated with a 1^{st} transmission configuration of the at least two transmission configurations, and determine a 2^{nd} SRS resource set of the at least two SRS resource sets configured for the first DCI format as an SRS resource set associated with a 2^{nd} transmission configuration of the at least two transmission configurations.

In an implementation, the determining module 31 is configured to: in a case that the transmission configuration of the CG is at least two transmission configurations, if at least two SRS resource sets are configured for any one DCI format of the at least two DCI formats, determine a 1^{st} SRS resource set of the at least two SRS resource sets configured for the any one DCI format as an SRS resource set associated with a 1^{st} transmission configuration of the at least two transmission configurations, and determine a 2^{nd} SRS resource set of the at least two SRS resource sets configured for the any one DCI format as an SRS resource set associated with a 2^{nd} transmission configuration of the at least two transmission configurations.

According to the CG transmission apparatus provided in this embodiment of this application, in a case that quantities of SRS resource sets configured for at least two DCI formats are different or only one DCI format is configured, the CG transmission apparatus may determine target SRS resource set(s) associated with a transmission configuration of a CG according to the SRS resource sets configured for the at least two DCI formats or an SRS resource set configured for the one DCI format, to determine a transmission manner of the CG. That is, the CG transmission apparatus uses one or more SRS resources of all SRS resource sets configured for the at least two DCI formats as an SRS resource set for transmitting a PUSCH of the CG or uses one or more SRS resources of all SRS resource sets configured for the only one configured DCI format as an SRS resource set for transmitting a PUSCH of the CG. Therefore, when the quantities of SRS resource sets configured for the at least two DCI formats are different or only the one DCI format is configured, the CG transmission apparatus can accurately determine the transmission manner of the CG, so that the CG transmission apparatus transmits the PUSCH of the CG.

The CG transmission apparatus in this embodiment of this application may be UE, for example, UE with an operating system, or may be a component in the UE, for example, an integrated circuit or a chip. The UE may be a terminal, or may be another device other than the terminal. For example, the UE may include but is not limited to the foregoing listed types of the UE 11. The another device may be a server, a Network Attached Storage (NAS), or the like. This is not specifically limited in this embodiment of this application.

The CG transmission apparatus provided in this embodiment of this application can implement the processes implemented by the UE in the foregoing method embodiment, and achieve a same technical effect. To avoid repetition, details are not described herein again.

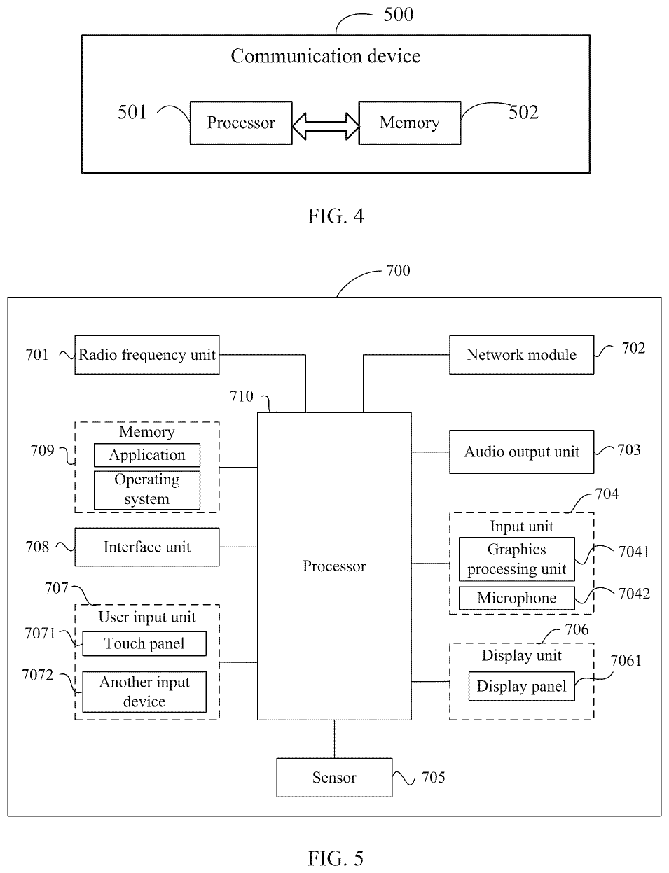

As shown in FIG. 4, an embodiment of this application further provides a communication device 500, including a processor 501 and a memory 502, where the memory 502 stores a program or an instruction that can be run on the processor 501. For example, when the communication device 500 is UE, the program or the instruction is executed by the processor 501 to implement the steps of the foregoing method embodiment on the UE side, and a same technical effect can be achieved. To avoid repetition, details are not described herein again.

An embodiment of this application further provides UE, including a processor and a communication interface. The processor is configured to determine, in a case that quantities of SRS resource sets configured for at least two DCI formats are different or only one DCI format is configured, target SRS resource set(s) associated with a transmission configuration of a CG according to the SRS resource sets configured for the at least two DCI formats or an SRS resource set configured for the one DCI format. The communication interface is configured to transmit a PUSCH of the CG according to the transmission configuration of the CG and the target SRS resource set. This UE embodiment corresponds to the foregoing method embodiment on the UE side. Each implementation process and implementation of the foregoing method embodiment may be applicable to this UE embodiment, and a same technical effect can be achieved. FIG. 5 is a schematic structural diagram of hardware of UE according to an embodiment of this application.

UE 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the UE 700 may further include the power supply (for example, a battery) that supplies power to each component. The power supply may be logically connected to the processor 710 by using a power supply management system, so as to manage functions such as charging, discharging, and power consumption by using the power supply management system. The UE structure shown in FIG. 5 constitutes no limitation on the UE, and the UE may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 or another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and a memory of any other proper type.

The processor 710 may include one or more processing units. In some embodiments, an application processor and a modem processor are integrated into the processor 710. The application processor mainly processes an operating system, a user interface, an application, and the like. The modem processor mainly processes a wireless communication signal, for example, a baseband processor. It can be understood that, the modem processor may not be integrated into the processor 710.

The processor 710 is configured to determine, in a case that quantities of SRS resource sets configured for at least two DCI formats are different or only one DCI format is configured, target SRS resource set(s) associated with a transmission configuration of a CG according to the SRS resource sets configured for the at least two DCI formats or an SRS resource set configured for the one DCI format.

The radio frequency unit 701 is configured to transmit a PUSCH of the CG according to the transmission configuration of the CG and the target SRS resource set.

According to the UE provided in this embodiment of this application, in a case that quantities of SRS resource sets configured for at least two DCI formats are different or only one DCI format is configured, the UE may determine target SRS resource set(s) associated with a transmission configuration of a CG according to the SRS resource sets configured for the at least two DCI formats or an SRS resource set configured for the one DCI format, to determine a transmission manner of the CG. That is, the UE uses one or more SRS resources of all SRS resource sets configured for the at least two DCI formats as an SRS resource set for transmitting a PUSCH of the CG or uses one or more SRS resources of all SRS resource sets configured for the only one configured DCI format as an SRS resource set for transmitting a PUSCH of the CG. Therefore, when the quantities of SRS resource sets configured for the at least two DCI formats are different or only the one DCI format is configured, the UE can accurately determine the transmission manner of the CG, so that the UE transmits the PUSCH of the CG.

The UE provided in this embodiment of this application can implement the processes implemented by the UE in the foregoing method embodiment, and achieve a same technical effect. To avoid repetition, details are not described herein again.

An embodiment of this application further provides a readable storage medium. The readable storage medium stores a program or an instruction, and the program or the instruction is executed by a processor to implement the processes of the foregoing method embodiment, and a same technical effect can be achieved. To avoid repetition, details are not described herein again.

The processor is a processor in the UE in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing method embodiment, and a same technical effect can be achieved. To avoid repetition, details are not described herein again.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A method for configured grant (CG) transmission, comprising:
determining, when quantities of sounding reference signal (SRS) resource sets configured for at least two downlink control information (DCI) formats are different or only one DCI format is configured, a target SRS resource set associated with a transmission configuration of a CG according to SRS resource sets configured for the at least two DCI formats or an SRS resource set configured for the one DCI format; and
transmitting a physical uplink shared channel (PUSCH) of the CG according to the transmission configuration of the CG and the target SRS resource set.

2. The method according to claim 1, wherein the determining a target SRS resource set associated with a transmission configuration of a CG according to SRS resource sets configured for the at least two DCI formats or an SRS resource set configured for the one DCI format comprises:
when the transmission configuration of the CG is one transmission configuration, determining a 1^{st} SRS resource set of SRS resource sets configured for a target DCI format as the target SRS resource set, wherein the target DCI format is the one DCI format or any DCI format of the at least two DCI formats.

3. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is one transmission configuration, and when at least one SRS resource set is configured for a first DCI format of the at least two DCI formats, determining a 1^{st} SRS resource set of the at least one SRS resource set as the target SRS resource set.

4. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is one transmission configuration, and when no SRS resource set is configured for a first DCI format of the at least two DCI formats or only a second DCI format is configured, determining a 1^{st} SRS resource set of an SRS resource set configured for the second DCI format as the target SRS resource set.

5. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is one transmission configuration, and when at least two SRS resource sets are configured for one DCI format of the at least two DCI formats and no SRS resource set is configured for another DCI format of the at least two DCI formats, determining a 1^{st} SRS resource set of the at least two SRS resource sets as the target SRS resource set;
or
when the transmission configuration of the CG is one transmission configuration, and when only the one DCI format is configured and at least two SRS resource sets are configured for the one DCI format, determining a 1^{st} SRS resource set of the at least two SRS resource sets as the target SRS resource set.

6. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is one transmission configuration, and when one SRS resource set is configured for one DCI format of the at least two DCI formats, determining the one SRS resource set as the target SRS resource set.

7. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is one transmission configuration, determining at least one SRS resource set is configured for the target DCI format of the two DCI formats.

8. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is two transmission configurations, determining at least two SRS resource sets are configured for the target DCI format of the two DCI formats.

9. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is one transmission configuration, when no SRS resource set is configured for the target DCI format, ignoring, by a terminal, target parameter indication(s) in the transmission configuration of the CG.

10. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is two transmission configurations, when only one SRS resource set is configured for the target DCI format, ignoring, by a terminal, a 2^{nd} transmission configuration of the CG.

11. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when no SRS resource set is configured for the target DCI format, transmitting, by a terminal, the CG by using a single-antenna port.

12. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when no SRS resource set is configured for a target DCI format, determining an SRS resource set in a target configuration as the SRS resource set.

13. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is at least two transmission configurations, and when no SRS resource set is configured for one DCI format of the at least two DCI formats and one SRS resource set is configured for another DCI format of the at least two DCI formats, determining the one SRS resource set as an SRS resource set associated with a 1^{st} transmission configuration and a 2^{nd} transmission configuration of the at least two transmission configurations;
or
when the transmission configuration of the CG is at least two transmission configurations, and when only the one DCI format is configured and one SRS resource set is configured for the one DCI format, determining the one SRS resource set as an SRS resource set associated with a 1^{st} transmission configuration and a 2^{nd} transmission configuration of the at least two transmission configurations.

14. The method according to claim 13, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is at least two transmission configurations, and when only the one DCI format is configured and at least two SRS resource sets are configured for the one DCI format, determining a 1^{st} SRS resource set of the at least two SRS resource sets configured for the one DCI format as an SRS resource set associated with a 1^{st} transmission configuration of the at least two transmission configurations, and determining a 2^{nd} SRS resource set of the at least two SRS resource sets configured for the one DCI format as an SRS resource set associated with a 2^{nd} transmission configuration of the at least two transmission configurations.

15. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is at least two transmission configurations, and when at least two SRS resource sets are configured for only one DCI format of the at least two DCI formats, determining at least two SRS resource sets of the SRS resource sets configured for the at least two DCI formats as SRS resource sets associated with the at least two transmission configurations, wherein the at least two transmission configurations are associated, in a one-to-one manner, with the at least two SRS resource sets of the SRS resource sets configured for the at least two DCI formats.

16. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is at least two transmission configurations, and when no SRS resource set is configured for one DCI format of the at least two DCI formats and at least two SRS resource sets are configured for another DCI format of the at least two DCI formats, determining a 1^{st} SRS resource set of the at least two SRS resource sets configured for the another DCI format as an SRS resource set associated with a 1^{st} transmission configuration of the at least two transmission configurations, and determining a 2^{nd} SRS resource set of the at least two SRS resource sets configured for the another DCI format as an SRS resource set associated with a 2^{nd} transmission configuration of the at least two transmission configurations.

17. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is at least two transmission configurations, and when one SRS resource set is configured for a first DCI format of the at least two DCI formats and at least two SRS resource sets are configured for a second DCI format of the at least two DCI formats,
determining the one SRS resource set as an SRS resource set associated with a 1^{st} transmission configuration of the at least two transmission configurations, and determining a 2^{nd} SRS resource set of the SRS resource sets configured for the second DCI format as an SRS resource set associated with a 2^{nd} transmission configuration of the at least two transmission configurations; or
determining a 1^{st} SRS resource set of the SRS resource sets configured for the second DCI format as an SRS resource set associated with a 1^{st} transmission configuration of the at least two transmission configurations, and determining a 2^{nd} SRS resource set of the SRS resource sets configured for the second DCI format as an SRS resource set associated with a 2^{nd} transmission configuration of the at least two transmission configurations.

18. The method according to claim 1, wherein the determining, when quantities of SRS resource sets configured for at least two DCI formats are different or only one DCI format is configured, a target SRS resource set associated with a transmission configuration of a CG according to SRS resource sets configured for the at least two DCI formats or an SRS resource set configured for the one DCI format comprises:
when the transmission configuration of the CG is at least two transmission configurations, and when at least two SRS resource sets are configured for a first DCI format of the at least two DCI formats, determining a 1^{st} SRS resource set of the at least two SRS resource sets configured for the first DCI format as an SRS resource set associated with a 1^{st} transmission configuration of the at least two transmission configurations, and determining a 2^{nd} SRS resource set of the at least two SRS resource sets configured for the first DCI format as an SRS resource set associated with a 2^{nd} transmission configuration of the at least two transmission configurations.

19. User equipment (UE), comprising: a memory storing a computer program; and a processor coupled to the memory and configured to execute the computer program to perform operations comprising:
determining, when quantities of sounding reference signal (SRS) resource sets configured for at least two downlink control information (DCI) formats are different or only one DCI format is configured, a target SRS resource set associated with a transmission configuration of a CG according to SRS resource sets configured for the at least two DCI formats or an SRS resource set configured for the one DCI format; and
transmitting a physical uplink shared channel (PUSCH) of the CG according to the transmission configuration of the CG and the target SRS resource set.

20. A non-transitory computer-readable storage medium, storing a computer program, when the computer program is executed by a processor, causes the processor to perform operations comprising:
determining, when quantities of sounding reference signal (SRS) resource sets configured for at least two downlink control information (DCI) formats are different or only one DCI format is configured, a target SRS resource set associated with a transmission configuration of a CG according to SRS resource sets configured for the at least two DCI formats or an SRS resource set configured for the one DCI format; and
transmitting a physical uplink shared channel (PUSCH) of the CG according to the transmission configuration of the CG and the target SRS resource set.
